(19) United States
(12) Patent Application Publication
(10) Pub. No.: US 2014/0195152 A1
(43) Pub. Date: Jul. 10, 2014

(54) Autonomous Velocity Sensing by Time Dilation

(71) Applicant: Robert S. Neiswander, Cambria, CA (US)

(72) Inventor: Robert S. Neiswander, Cambria, CA (US)

(21) Appl. No.: 13/738,120

(22) Filed: Jan. 10, 2013

(51) Int. Cl. G01C 21/16

(52) U.S. Cl. CPC G01C 21/165
USPC 701/478; 701/507

(57) ABSTRACT

A system and method for determination of a vehicle or crafts velocity uses on-board time dilation measurements of a moving signal generator and signal generator movement measurements to determine a velocity vector of a craft or vehicle.

### BACKGROUND OF THE INVENTION

1. Field of the Invention

This invention relates to a system and method for determination of a vehicle's or craft's velocity using time dilation measurements made by onboard instruments.

2. Description of Related Art

Reliance upon external references and signals in measuring a mobile craft's motion creates a dependence on the availability, accuracy and promptness of the external links. Applications that are especially vulnerable to this dependency include,

Space Probes:

Transmission delays cannot be avoided. Signals from an earth based control center may be delayed by minutes. Measurements leading to emergency quick reaction corrections of the flight path are limited to those made by on-board instruments; none of these instruments measures the craft's velocity.

Submarine Navigation:

When submerged the submarine is isolated from all external references and signals except long wavelength radio communication, sonar and the earth's magnetic field. The measured velocity vector of the craft with respect to its surrounding medium is inaccurate, and the conversion of this velocity to the geodetic coordinate frame (the frame attached to the spinning earth) must be corrected for the ocean's current. Navigation by sonar requires a topological map of the ocean floor.

Reentry and Flight Test Vehicles:

When a reentry vehicle or an aircraft loses control of its flight path, the principal source of information regarding its motion is from ground based observation of its position. On board instruments measuring air speed and rate of ascent/descent are unreliable. This lack of on-board, real time measurements jeopardizes the recovery maneuvers and limits the effectiveness of the subsequent diagnostics.

Velocity can be measured indirectly by an inertial navigation system (INS) containing three orthogonal accelerometers mounted on a stable table defining directions. The measured vector acceleration is time integrated producing the accumulated change in velocity. The initial velocity vector, however, must be determined by external signals or fields. Examples of this dependency are typified in the referenced patents:

U.S. Pat. No. 7,890,260 by Ring^{[1]} describes a method to improve location accuracy by combining the velocity change obtained by integration of acceleration and the artificially generated velocity obtained from GPS.

U.S. Pat. No. 7,248,967 B2 by Hagstedt^{[2]} describes a quasi-autonomous method in which the velocity change obtained by integration of acceleration is combined with the velocity obtained by a natural external source, the earth's magnetic field. He employs a magnetic measurement unit to register a field vector of the terrestrial magnetic field. The accuracy of the velocity depends upon the accuracy of the magnetic field map at hand.

The prior art contains no techniques for measuring vector velocity independent of artificial signals and natural fields.

### SUMMARY OF THE INVENTION

Through years of operation, the Global Positioning System (GPS) has established that clocks slow with motion, that time intervals at a moving system are dilated by the velocity of the system relative to the GPS coordinate frame. This frame is three-dimensional, Euclidean, non-rotating in inertial space and anchored at the earth's barycenter (the earth-moon center of gravity). Time dilation varies with the magnitude of the GPS velocity therefore time dilation can be utilized as a measure of this velocity.

Sensing velocity by time dilation is simple in concept. The sensor determines the magnitude and direction of its velocity by measuring the time dilation of a stable time interval such as the period of an atomic oscillator. This oscillator is moving at a known velocity vector that adds to the unknown velocity. As this controlled velocity vector rotates the magnitude of the sum velocity varies, reaching a maximum when the controlled and the unknown vector velocities point in the same direction, and a minimum a half turn later. The maximum and minimum of the sum velocity can be identified by the maximum and minimum of the velocity induced time dilation of the oscillator period, or the reciprocal, the minimum and maximum oscillator frequencies. The magnitude of the unknown velocity is a first order function of the maximum and minimum dilations. This measurement requires no artificial or natural external references. The measurement is in real time.

### BRIEF DESCRIPTION OF THE DRAWINGS

The method of sensing and measuring velocity is explained more clearly by example embodiments and with reference to the attached drawings.

FIG. 1 shows the sensor geometry with basic GPS coordinates.

FIG. 2 shows the arrangement of components referred to in the description of the sensor.

FIG. 3 presents a flow chart of the signals and signal processing.

### DETAILED DESCRIPTION OF THE INVENTION

In Section 6.4 of GPS Theory and Practice by Hofmann-Wellenhof et al^{[1]}, the authors describe the relativistic properties of the Global Positioning System (GPS), clocks must be corrected for both motion-induced and gravity-induced time dilation. The motion-induced dilation factor is drawn from Einstein's Special Theory of Relativity and the gravity-induced dilation factor is drawn from his General Theory of Relativity. To isolate the motion effects, all clocks are assumed to be at the same gravity potential

Velocity is relative; the GPS reference frame is Euclidean, three-dimensional, non-rotating in inertial space, and anchored at the earth's barycenter. All GPS velocities reference this GPS coordinate frame. The GPS velocity creates a motion induced dilation factor

$${γ}_{V} = \frac{1}{\sqrt{1 - {V}^{2} / {c}^{2}}} \approx 1 + \frac{1}{2} \frac{{V}^{2}}{{c}^{3}}$$

where c is the velocity of light and V is the GPS velocity of the oscillator. Motion dilates the oscillator's period and contracts the oscillator's frequency. When stationary, the oscillator has a frequency f₀, when moving at GPS velocity V the oscillator's frequency is contracted to f₁=γ_{V}⁻¹f₀, where

$${γ}_{V}^{- 1} = \sqrt{1 - \frac{{V}^{2}}{{c}^{2}}} \approx 1 - \frac{1}{2} \frac{{V}^{2}}{{c}^{2}}$$

The sensor measures the magnitude of its GPS vector velocity and the vector direction referencing the sensor axes. Typically these axes are, 1) GPS coordinates, 2) geodetic coordinates. or 3) body fixed coordinates. The angles measured with one reference can be converted to another system by conventional transformations. For example a GPS velocity vector is transformed to a geodetic velocity vector by the subtraction of the earth's peripheral velocity vector from the GPS vector.

Whereas the current GPS operates in a region in which the earth's gravity is dominant, a GPS could be installed at any object sufficiently massive to create an extended gravity field. For example, a sun-centered GPS would have a non-rotating frame anchored at the sun's barycenter as a reference for its GPS velocities. Within the region in which the sun's gravity potential is dominant, these velocities determine the motion induced time dilation factors of moving clocks as compared to a stationary clock.

In summary, the method of sensing velocity described herein measures the magnitude of the GPS velocity vector, and the vector angles referencing the sensor axes. This vector velocity can be converted to other reference frames by conventional coordinate transformations. Velocities referencing the earth-centered GPS coordinate frame dilate time in the region in which the earth's gravity is dominant. Velocities referencing other masses, such as Jupiter or the sun, dilate time in the regions in which the mass sponsored gravity field is dominant.

### Sensor Geometry

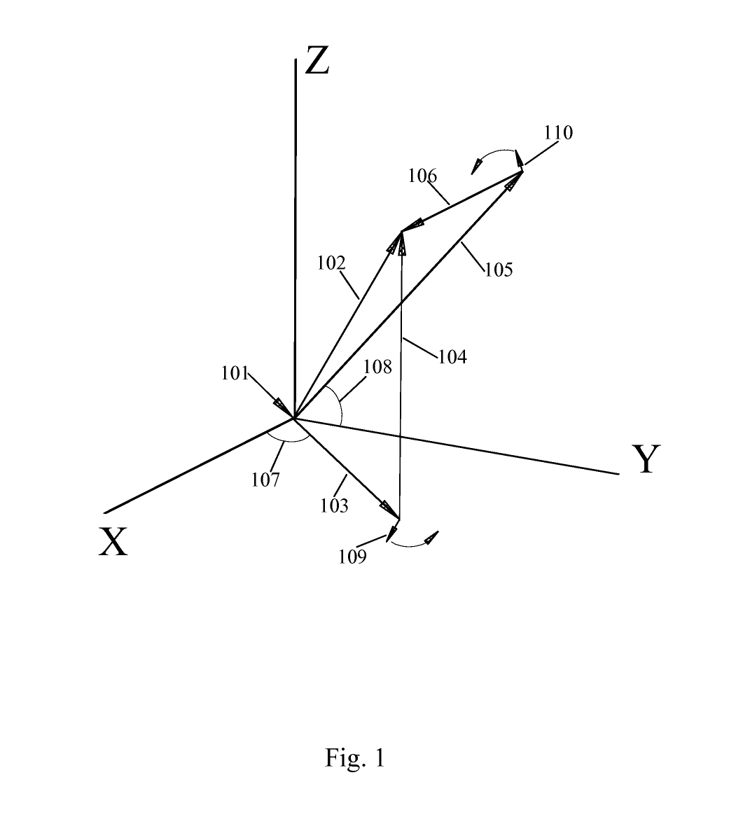

The sensor may have one, two or three modules with scan planes perpendicular to each other. In the basic embodiment (see FIG. 1), the XYZ axes of the coordinate frame (101), defining the direction of the GPS vector velocities at the module, are parallel to the GPS reference frame. Typically the Z-axis is parallel to the earth's spin axis, and the XY plane is non-rotating in inertial space and parallel to the earth's equatorial plane. The measured velocity is the GPS vector velocity of the sensor.

The two module embodiment, also shown in FIG. 1, is a typical example, The XY plane is the scan plane of the XY Module and the YZ plane is the scan plane of the YZ Module. The unknown velocity V (102) projects as V_{XY} (103) on the XY plane and as V_{YZ} (105) on the YZ plane. These projections create two right triangles. The XY Module triangle has sides V_{XY} and V_{Z} (104) and hypotenuse V, and the YZ Module triangle has sides V_{YZ} and V_{X} (106) and hypotenuse V. Not shown, the ZX Module has sides V_{ZX} and V_{Y} and hypotenuse V.

Angle φ lies in the XY plane with φ=0 at the X-axis. The vector V_{XY} lies at angle φ_{V}. (107). Angle θ lies in the YZ plane with θ=0 at the Y-axis. The vector V_{YZ} lies at angle θ_{V}. (108). Not shown, angle ψ lies in the ZX-plane with ψ=0 at the Z-axis. The vector V_{ZX} lies at angle ψ_{V}.

Projected components V_{XY}, V_{YZ} and V_{ZX} of the GPS vector velocity V can be transformed to Cartesian components by,

V_{X}=V_{XY} cos α_{V}=V_{ZX} sin ψ_{V} V_{Y}=V_{XY} sin α_{V}=V_{YZ} cos β_{V} V_{Z}=V_{YZ} sin β_{V}=V_{ZX} cos ψ_{V}

The scanning mechanism of the XY Module moves its oscillator at velocity ν₁ (109) where ν₁ is in the XY plane and rotates 2π radians each scan revolution. The sum velocity V_{XY}+ν₁ is a maximum when ν₁ points in the same direction as V_{XY} and a minimum, when ν₁ points opposite to V_{XY}. When V_{XY}+ν₁ is maximum the GPS velocity V+ν₁ of the signal generator is maximum creating maximum dilation of the oscillation period, and minimum oscillation frequency. At minimum frequency, ν₁ points at angle φ_{V}. When V_{XY}+ν₁ is minimum the GPS velocity V+ν₁ of the signal generator is minimum creating minimum dilation of the oscillation period and maximum frequency. At maximum frequency, ν₁ points at angle φ_{V}+π.

The scanning mechanism of the YZ Module moves its oscillator at velocity ν₂ (110), where ν₂ is in the YZ plane and rotates 2π radians each scan revolution. The sum velocity V_{YZ}+ν₂ is a maximum when ν₂ points in the same direction as V_{YZ} and a minimum when ν₂ points opposite to V_{YZ}. When V_{YZ}+ν₂ is maximum, the GPS velocity V+ν₂ of the signal generator is maximum creating maximum time dilation. At this maximum, ν₂ points at angle θ_{V}. When V_{YZ}+ν₂ is minimum the GPS velocity V+ν₂ of the signal generator is minimum creating minimum dilation of the oscillation period and maximum frequency. At maximum frequency, ν₂ points at angle θ_{V}+π.

The geometry of single module embodiment consists of the XY Module scanning a horizontal XY plane. The geometry of the three module embodiment includes the ZX scanning plane and projected velocity vector V_{ZX}.

When the sensor coordinate system is other than GPS, coordinate transformations are necessary to properly interpret the sensor measurements.

Basic GPS Coordinate Frame:

Typically the XY plane is the earth's equatorial plane. The Z-axis is the earth's spin axis. The extension of the X-axis is a fixed point on the surrounding celestial sphere. Axes of the coordinate frame defining GPS velocities at the sensor are parallel to the GPS coordinate frame axes

Geodetic Coordinates:

Typically the sea level earth is represented as an ellipsoid of revolution with coordinates longitude, latitude and elevation above sea level. A point at rest on the earth's surface moves at GPS velocity V_{PER}, where the magnitude of the peripheral velocity V_{PER} is defined by its latitude and elevation, and its direction is due east. The geodetic horizontal plane is tangent to the ellipsoid at the sensor latitude and longitude, or parallel to this plane at sensor elevation. Typically the horizontal plane is the XY plane and is compass oriented with X pointing north.

In this embodiment, the sensor measures the magnitude of its GPS velocity vector V and the direction of the velocity vector referencing its horizontal coordinate frame. The difference vector velocity V_{EARTH}=V−V_{PER} is the geodetic velocity of the sensor. The horizontal component of V_{EARTH} is the sensor “ground velocity”; the time integral of the velocity is the ground track. The vertical component of V_{EARTH} is the sensor's rate of ascent/descent.

Body Axes:

This is the simplest installation. If the body is flexible, the two modules are mounted on a common supporting plate. If the body is rigid the modules can be separated. In one embodiment (referencing the axis designation of FIG. 1) X is the roll axis, Y is the pitch axis and Z is the yaw axis. To determine the sensor's V_{EARTH}, the body-fixed coordinates must be transformed to geodetic coordinates. This transformation requires a three-axis, gyroscopically controlled horizontal table and a directional gyro slaved to north by the earth's magnetic field or by the earth's spin.

Extra-Terrestrial Systems:

In the region in which a massive body's gravity is dominant, time is dilated by motion with respect to a non-rotation frame attached to the body. This body could be another planet, the sun, or the black holes at the core of our galaxy.

### Sensor Oscillator

At the heart of the sensor system, the oscillator defines the system's configuration, its feasibility and its performance. The scanning mechanism rotates at Ω radians/second with an arm length L·meters, moving the oscillator in a circle. In the XY Module, for example, the controlled vector velocity of the oscillator is ν₁ where the amplitude is ν₁=LΩ and its direction is φ=Ωt.

As shown in FIG. 1, the XY Module oscillator GPS velocity V_{OSC-1} has three orthogonal components: 1) V_{XY}+ν₁ cos(Ωt−φ_{V}) pointing in the φ_{V} direction, 2) ν₁ sin(Ωt−φ_{V}) in the XY-plane and perpendicular to φ_{V}, and 3) V_{Z} perpendicular to the XY-plane. Thus,

$$\begin{matrix}{V}_{OSC - 1}^{2} = {[ {V}_{XY} + {v}_{1} cos ( Ω t - {ϕ}_{V} ) ]}^{2} + {[ {v}_{1} sin ( Ω t - {ϕ}_{V} ) ]}^{2} + {[ {V}_{Z} ]}^{2} \\ = {V}_{XY}^{2} + {V}_{Z}^{2} + {v}_{1}^{2} [ {cos}^{2} ( Ω t - {ϕ}_{V} ) + {sin}^{2} ( Ω t - {ϕ}_{V} ) ] + \\ 2 {V}_{XV} {v}_{1} cos ( Ω t - {ϕ}_{V} ) \\ = {V}^{2} + {v}_{1}^{2} + 2 {V}_{XV} {v}_{1} cos ( Ω t - {ϕ}_{V} )\end{matrix}$$

Rather than focus on the oscillator period, the preference of technical literature is its reciprocal, oscillator frequency. The signal from the moving oscillator is beamed to a vehicle-stationary frequency analyzer. The reciprocal time dilation factor of the oscillator is γ_{OSC-1}⁻¹=\sqrt{1−V_{OSC-1}²/c²} and the reciprocal time dilation factor of the analyzer is \sqrt{1−V²/c²}, so the signal at the analyzer is,

$$\begin{matrix}{f}_{XY} = \frac{{γ}_{OSC - 1}^{- 1}}{{γ}_{V}^{- 1}} {f}_{0} \\ = {f}_{0} \frac{\sqrt{1 - {V}_{OSC - 1}^{2} / {c}^{2}}}{\sqrt{1 - {V}^{2} / {c}^{2}}} \\ \approx {f}_{0} [ 1 - \frac{1}{2} \frac{{v}_{1}^{2}}{{c}^{3}} - \frac{{V}_{XY} {v}_{1}}{{c}^{2}} cos ( Ω t - {ϕ}_{V} ) ]\end{matrix}$$

The controlled velocity ν₁ is less than 10 meters/second, the term

$$\frac{1}{2} \frac{{v}_{1}^{2}}{{c}^{2}}$$

is less than 10⁻¹⁵ and can be disregarded. The measured frequency is

$$Module XY$$

$${f}_{XY} \approx {f}_{0} - {f}_{0} \frac{{V}_{XY} {v}_{1}}{{c}^{2}} cos ( Ω t - {ϕ}_{V} ) = {f}_{0 } - δ {f}_{XY} cos ( Ω t - {ϕ}_{V} )$$

Controlled motion of the oscillator frequency modulates the oscillator carrier f₀ with an amplitude δf_{XY}. Similar analyses yield,

$$Module YZ$$

$${f}_{YZ} = {f}_{0} - {f}_{0} \frac{{V}_{YZ} {v}_{2}}{{c}^{2}} cos ( Ω t - {θ}_{V} ) = {f}_{0 } - δ {f}_{YZ} cos ( Ω t - {θ}_{V} )$$

$$Module ZX$$

$${f}_{ZX} = {f}_{0} - {f}_{0} \frac{{V}_{ZX} {v}_{3}}{{c}^{2}} cos ( Ω t - {ψ}_{V} ) = {f}_{0 } - δ {f}_{ZX} cos ( Ω t - {ψ}_{V} )$$

The amplitudes of the frequency modulations are:

$$δ {f}_{XY} = {f}_{0} \frac{{V}_{XY} {v}_{1}}{{c}^{2}} \text{:} δ {f}_{YZ} = {f}_{0} \frac{{V}_{YZ} {v}_{2}}{{c}^{2}} δ {f}_{ZX} = {f}_{0} \frac{{V}_{ZX} {v}_{3}}{{c}^{2}}$$

Considerations in selecting the oscillator include stability and modulation measurability. In Module XY, for example, the modulation amplitude depends upon the projected velocity V_{XY}, the controlled velocity ν₁ and the carrier frequency f₀. Typically V_{XY} lies between 0 and 5000 meter/second, and ν₁ is of the order 10 meter/second: So δf_{XY} varies from 0 to (5×10⁻¹³)f₀. The frequency modulation amplitudes for representative ultra-stable oscillators are:

| | Wavelength | Frequency | Amplitude δf |
|---|---|---|---|
| Oscillator | (meters) | (Hertz) | (Hertz) |
| Rubidium | 43 × 10⁻³ | 6.8 × 10⁹ | 0-.003 |
| HeNe | 630 × 10⁻⁹ | 473 × 10¹² | 0-240 |
| Mercury ion | 282 × 10⁻⁹ | 1.1 × 10¹⁵ | 0-530 |

The rubidium microwave oscillator offers a maximum amplitude of only 3 milliradians. By contrast, the optical HeNe and mercury oscillators provide maximum amplitudes of greater than 100 Hertz.

### Component Arrangement

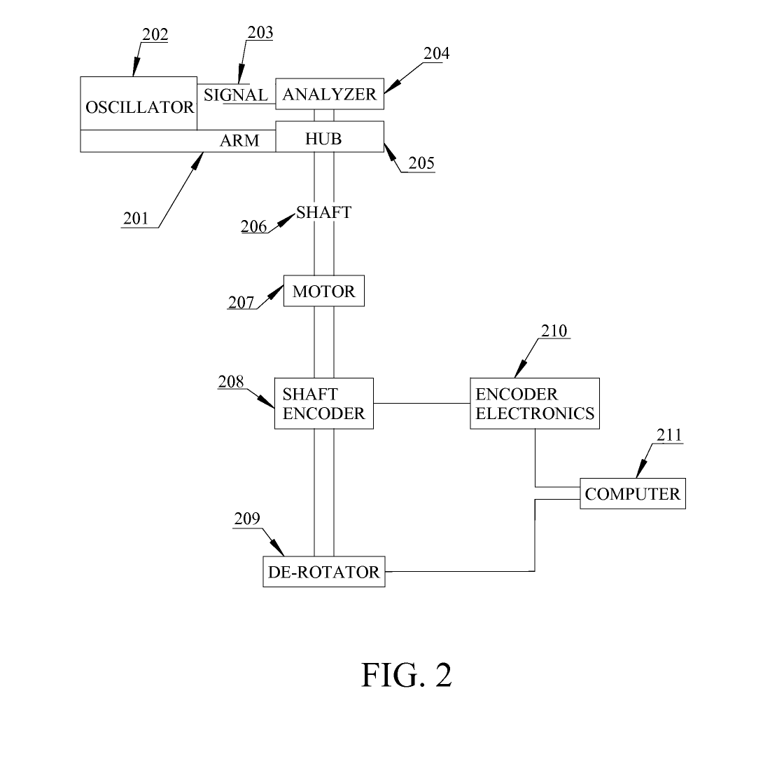

The sensor modules are identical, oriented with their scan planes perpendicular to each other. The arrangement of components within a module is shown in FIG. 2, An oscillator (202) generates an optical signal (203) that is collimated and directed radially to a frequency analyzer (204) atop a hub (205). The oscillator is moved by a scan mechanism comprised of an arm (201) attached to the hub, a hollow shaft (206) rotating the hub, a motor (207) rotating the shaft, hub and arm. Angular position of the shaft is measured by a shaft encoder (208) and encoder electronics (210). The analyzer output signal is transferred to a computer (211) by a conduit (not shown) following the centerline of the shaft to a de-rotator (209) and thence to the computer. Alternatively, the connection is wireless. The encoder electronics connect to the computer.

In one embodiment referencing the GPS coordinate frame, a gyro stabilized table (not shown) is included to transform body coordinates to GPS coordinates. In another embodiment the stable table supports the modules.

In another embodiment referencing the geodetic coordinates, the body-fixed sensor system includes a horizontal reference and a directional gyro (not shown). In another embodiment the sensor axes are slaved to the geodetic horizontal plane and geodetic direction. In these embodiments the sensor may consist of one, two or three modules.

### Signal Processing

Signal generation and processing are identical in the sensor modules, but their scanning planes are orthogonal. Typically, in the three module embodiment, the XY Module the scan plane is parallel to the GPS XY plane, the YZ Module scan plane is parallel to the GPS YZ plane, and the ZX Module scan plane is parallel to the GPS ZX plane.

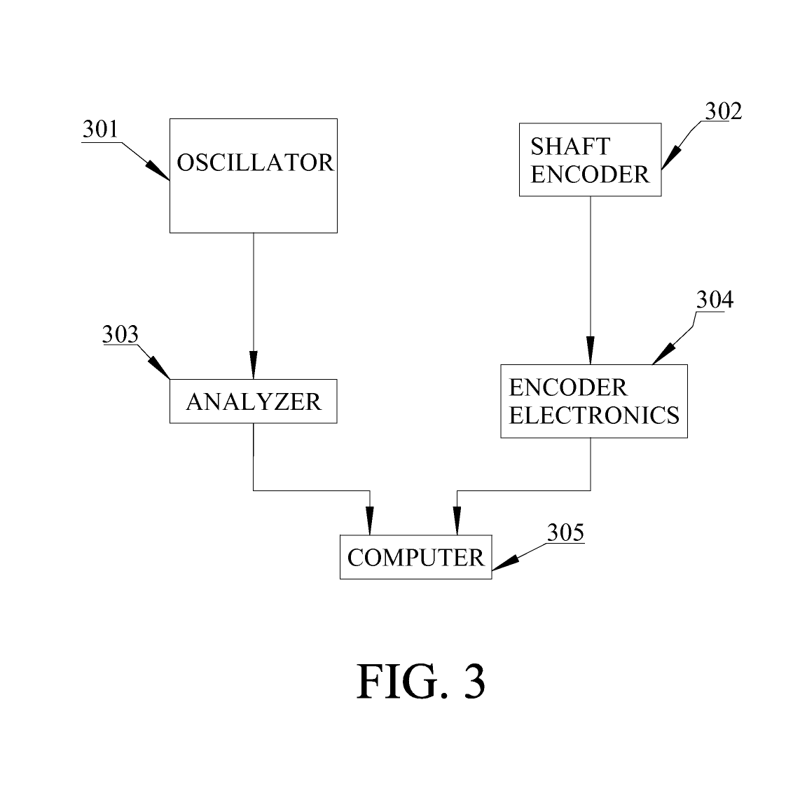

FIG. 3 shows, as an example, XY Module processing. From its circular motion, the oscillator (201) frequency modulates its optical carrier:

f_{XY}=f₀−δf_{XY} cos(Ωt−φ_{V}).

This optical signal is demodulated at the analyzer (303) creating a series of samples of the modulation sinusoidal envelope. This series is sent to the computer (305). In parallel the shaft encoder and its electronics (304) measures the direction of the oscillator motion, and enters this data in the computer.

There are three methods of demodulation;
1) Direct demodulation of the optical carrier. This presumes a new technology will become available.
2) Reduction of the optical carrier to a radio frequency carrier with conventional radio frequency modulation detection.
3) Reduction of the optical carrier to an audio frequency carrier with conventional audio frequency analysis.
   The carrier frequency can be reduced by generating a beat frequency between the modulated carrier and a second reference carrier. Typically this beat is produced by an interferometer or a heterodyne mixer.

The first operation of the XY computer is to tag each frequency sample with the scan angle φ at the sample time. The second step is to make a best fit of a sinusoidal function, typically representing a cycle or longer, to sets of the sampled data. Next, the computer determines from the smoothed sinusoid its amplitude δf_{XY} and its phase φ_{V}.

The analysis is simple. The projected GPS vector velocity V_{XY} has an amplitude:

$${V}_{XY} = \frac{{c}^{2}}{{v}_{1}} \frac{δ {f}_{XY}}{{f}_{0}}$$

pointing in the φ_{V} direction. By similar analyses, the YZ Module and ZX Module determine the magnitudes:

$${V}_{ZX} = \frac{{c}^{2}}{{v}_{2}} \frac{δ {f}_{YZ}}{{f}_{0}} pointing at {θ}_{V}$$

$${V}_{ZX} = \frac{{c}^{2}}{{v}_{3}} \frac{δ {f}_{ZX}}{{f}_{0}} pointing at {ψ}_{V}$$

The final operation is to transform the projected velocities into vector components of the GPS, geodetic, or body-fixed coordinate system.

Although specific embodiments have been described above, any arrangement that achieves the same purpose may be substituted for the specific embodiment. This application is intended to cover any adaptation of this method of sensing velocity. The descriptions of the invention provided are not intended to limit the invention, but rather the claims define the invention.

### Feasibility

The described velocity sensor is feasible. There is a worldwide effort to develop optical atomic clocks for satellites. Any of the optical oscillators resulting from this effort would be suitable for the velocity sensor. This is a rapidly evolving technology. As reported by the National Institute for Standards and Technology^{[2]}, a comparison of two mercury ion oscillators shows a remarkable short term fractional frequency instability of 5×10⁻¹⁶. With these or similar oscillators, proof of concept of the velocity sensor could be tested today.

One of the planned space experiments is the measurement of the gravitational redshift comparing a clock aboard the International Space Station and a ground clock^{[3]}. Both are high accuracy (10⁻¹⁶) clocks. The velocity sensor requires a similar accuracy, but the link between it oscillators is several centimeters rather than 400 kilometers through the earth's atmosphere. The satellite velocity sensor would be amongst the first applications of he optical frequency oscillators.

The invention claimed is:

1. A method of determining a vector velocity of a craft or vehicle by on-board measurements of motion-induced time dilation, the method comprising:
a. providing one or more oscillators producing multiple periodic measurements of oscillator motion velocity;
b. calculating the time dilation associated with the measurements of oscillator motion velocity; and
c. calculating the vector velocity of the craft from the time dilation calculations.

2. A method of determining a vector velocity of a craft or vehicle by on-board measurements and data processing, the method comprising:
a. providing an oscillator producing a periodic signal,
b. dilating the signal period by moving the oscillator,
c. measuring the oscillator motion,
d. measuring the signal period dilation by an analyzer with zero velocity,
e. periodically repeating steps b. through d. providing a set of period dilation measurements,
f. selecting maximum and minimum dilated periods from the set of period dilation measurements, and
g. determining the vector velocity from the maximum and minimum period dilations.

3. The method of claim 2 further comprising in step g. the velocity vector is GPS velocity vector determined by the period dilations.

4. The method of claim 2 further comprising transforming the GPS vector velocity to a geodetic velocity vector.

5. The method of claim 2 further comprising:
a. in step b. dilating the signal period by moving the oscillator in a circular path,
b. in step c measuring the direction and movement of the oscillator, and
c. in step g. determining the velocity vector from the maximum and minimum period dilations whereby the direction concurrent with the maximum dilated period includes a GPS velocity vector.

6. The method of claim 2 further comprising transforming the GPS velocity vector to a geodetic velocity vector.

7. A vector velocity system for a craft or vehicle containing one or more similar modules; each module comprising:
a. an oscillator producing a periodic signal,
b. a mechanism for moving the oscillator,
c. an encoder arranged to measure the oscillator motion,
d. an analyzer with zero velocity arranged to receive the signal from the moving oscillator and produce a measurement of the period dilation of the moving oscillator's signal,
e. a computer programmed to receive a set of multiple period dilation and motion measurements and select maximum and minimum periods from the set, and
f. the computer also programmed to determine a craft or vehicle vector velocity component from the maximum and minimum dilated periods.

8. The vector velocity sensor system of claim 7 further comprising the computer is programmed to determine a craft or vehicle GPS velocity vector component.

9. The vector velocity sensor of claim 7 further comprising the computer is programmed to determine a craft or vehicle geodetic vector velocity components.

10. The vector velocity sensor of claim 7 further comprising the computer is programmed to determine a craft or vehicle body axes velocity components,

11. The vector velocity sensor system of claim 7 further comprising the mechanism for moving the oscillator comprising:
a. an arm supporting said oscillator,
b. a hub attached to the arm,
c. a hollow shaft inserted into the said hub, and arm,
d. a motor rotating the shaft, hub, and arm.

12. The vector velocity sensor system of claim 10 further comprising the encoder arranged to measure the oscillator motion comprises a shaft encoder and electronics measuring the angle of the shaft.

13. The vector velocity sensor system of claim 10 further comprising an analyzer having zero velocity arranged to receive the signal from the moving signal oscillator.
